(19) United States
(12) Patent Application Publication
(10) Pub. No.: US 2002/0086772 A1
(43) Pub. Date: Jul. 4, 2002

(54) Engine automatic stop-restart control responsive to braking force

(76) Inventors: Tetsuya Abe, Nagoya-city (JP); Seiji Totsuka, Tokai-city (JP); Akira Kato, Anjo-city (JP)

Correspondence Address: LAW OFFICE OF DAVID G POSZ, 2000 L STREET, N.W., SUITE 200, WASHINGTON, DC, 20036, US

(21) Appl. No.: 09/962,266

(22) Filed: Sep. 26, 2001

(30) Foreign Application Priority Data
Dec. 28, 2000 (JP) 2000-400835

(51) Int. Cl. F16H 59/74

(52) U.S. Cl. 477/102

(57) ABSTRACT

In an engine automatic-restart control apparatus for vehicles, a braking force is checked whether it has become smaller than a first predetermined value. If the braking force is greater than the first predetermined value, it indicates that a vehicle is being at rest on a sloping road. Before restarting the engine, a driver reduces the applied brake so that the braking force becomes smaller than the first predetermined value. If the braking force has become smaller than the first predetermined value, an auxiliary braking force is applied before the engine is restarted. Thus, the vehicle is prevented from moving backward when the engine is restarted.

### CROSS REFERENCE TO RELATED APPLICATION

This application is based on and incorporates herein by reference Japanese Patent Application No. 2000-400835 filed on Dec. 28, 2000.

### BACKGROUND OF THE INVENTION

The present invention relates to an engine automatic stop-restart control for a vehicle. More particularly, the present invention relates to an engine automatic stop-restart control that provides a braking force for preventing a vehicle from moving when an engine of the vehicle is restarted from a rest state.

An engine automatic stop-restart control apparatus (an idle stop apparatus) automatically stops an engine when a vehicle is at rest at a cross in the course of running along a city street, and later on restarts the engine so as to improve fuel economy and exhaust gas emission.

In this type of control apparatus proposed in U.S. Pat. No. 6,135,920 (JP-A-12-008905), a road gradient sensor is used for detecting the gradient of the surface of a road. An auxiliary braking force other than the foot brake of a driver is generated for a road gradient exceeding a predetermined value so as to prevent the vehicle from moving backward when the engine is restarted on an ascending road. This sensor adds costs.

### SUMMARY OF THE INVENTION

It is thus an object of the present invention to provide an engine automatic stop-restart control capable of preventing a vehicle from moving when an engine is restarted on a sloping road without a road gradient sensor.

According to the present invention, an engine is automatically stopped when a braking force is applied to a vehicle, and the engine is automatically restarted when the braking force is reduced. When the engine is held stopped, the braking force is detected. If the detected braking force is reduced to a predetermined level, an auxiliary braking force is applied before the engine is restarted. Thus, even if the vehicle is on a sloping road which will cause backward movement of the vehicle, the vehicle is prevented from moving backward on the sloping road when the engine is restarted.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram showing an engine automatic stop-restart control apparatus according to a first embodiment of the present invention;

FIG. 2 is an operation diagram showing an operation of the first embodiment;

FIG. 3 is an operation diagram showing an operation of the first embodiment;

FIG. 4 is an operation diagram showing an operation of the first embodiment;

FIG. 5 is a flow diagram showing control processing executed in the first embodiment;

FIG. 6 is a flow diagram showing control processing executed in a second embodiment of the present invention;

FIG. 7 is an operation diagram showing operation of the second embodiment;

FIG. 8 is a flow diagram showing control processing executed in a modification of the second embodiment;

FIG. 9 is an operation diagram showing an operation of the modification of the second embodiment;

FIG. 10 is a flow diagram showing control processing executed in a third embodiment of the present invention;

FIG. 11 is an operation diagram showing an operation of the third embodiment;

FIG. 12 is a flow diagram showing control processing executed in a fourth embodiment of the present invention;

FIG. 13 is an operation diagram showing an operation of the fourth embodiment; and

FIG. 14 is a schematic diagram showing a hydraulic pressure circuit of a brake used in the embodiments.

### DETAILED DESCRIPTION OF THE PREFERRED EMBODIMENT

(First Embodiment)

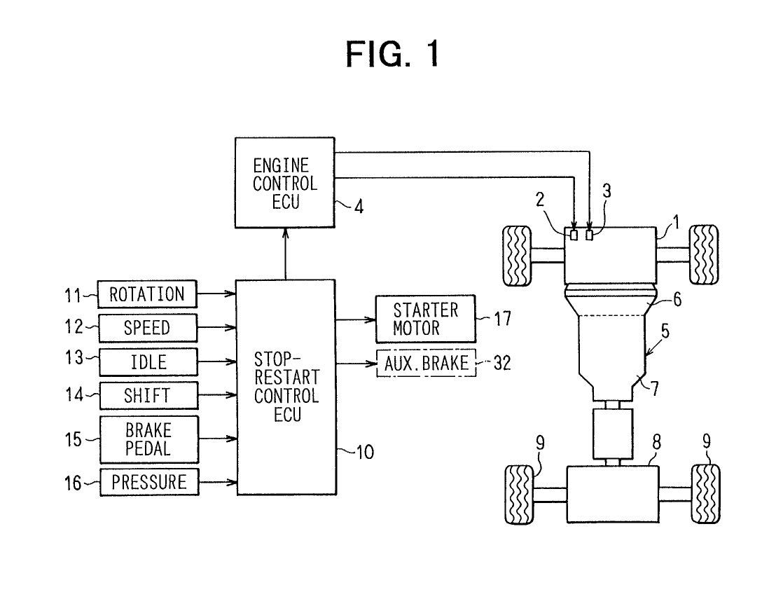

Referring first to FIG. 1, an engine 1 is mounted on a vehicle chassis. Fuel injectors (fuel injection valves) 2 and igniters 3 are mounted on the engine 1. An electronic control unit (ECU) 4 for control of the engine 1 computes a fuel injection quantity from signals representing quantities such as an inlet air volume, an engine speed and an engine cooling water temperature so as to provide an optimum air-fuel ratio mixture for the engine 1, by executing control processing to inject a proper fuel quantity from the injector 2 provided on an inlet pipe of each cylinder. In addition, the engine control ECU 4 controls the igniters 3 from signals representing the speed of the engine 1 and the state of the load to provide ignition sparks at optimum ignition timings.

On the other hand, an output shaft of the engine 1 is linked to an automatic transmission 5. The automatic transmission 5 comprises a torque converter 6, a transmission mechanism 7 driven by the output of the engine 1 through the torque converter 6 and a hydraulic circuit (not shown) for changing the gear ratio of the transmission mechanism 7 in accordance with the output of the engine 1. A shift lever (not shown) provided near a driver seat is operated to change the operation mode of the automatic transmission 5 from one range to another. The ranges include P (parking), R (reverse), N (neutral), D (drive), 3rd speed, 2nd speed and 1st (low) speed. The hydraulic circuit employed in the automatic transmission 5 sets the gear ratio of the transmission mechanism 7 so as to result in a speed optimum for the operating condition.

The output of the automatic transmission 5 is transmitted to a differential gear 8 for driving drive wheels 9. The vehicle also has an automatic stop-restart control ECU 10 for controlling the automatic stop-restart operation of the engine 1. The stop-restart control ECU 10 comprises a microcomputer, an input circuit and an output circuit.

The stop-restart control ECU 10 is connected to an engine rotation sensor 11, a vehicle speed sensor 12, an idle switch 13 and a shift position switch 14. These sensors provide the stop-restart control ECU 10 with detection signals, allowing the stop-restart control ECU 10 to obtain information on the rotation speed of the engine 1, the running speed of the vehicle, whether or not the accelerator pedal has been released (engine idle) and the position of the shift lever of the automatic transmission 5. In addition, the stop-restart control ECU 10 is also connected to a brake pedal operation quantity sensor 15. The brake pedal operation quantity sensor 15 is a sensor for converting the operation quantity θ of the brake pedal 20 into an electrical signal.

Furthermore, the stop-restart control ECU 10 is capable of outputting a fuel cut-off signal and an ignition cut-off signal to the engine control ECU 4 so as to stop the engine 1. Moreover, the stop-restart control ECU 10 is capable of outputting a fuel injection signal and an ignition signal to the engine control ECU 4 so as to carry out a fuel injection operation and an ignition operation. In addition, the stop-restart control ECU 10 is connected to a starter motor 17 to control and drive the starter motor 17. Furthermore, the stop-restart control ECU 10 is connected to an auxiliary brake actuator which operates a foot brake.

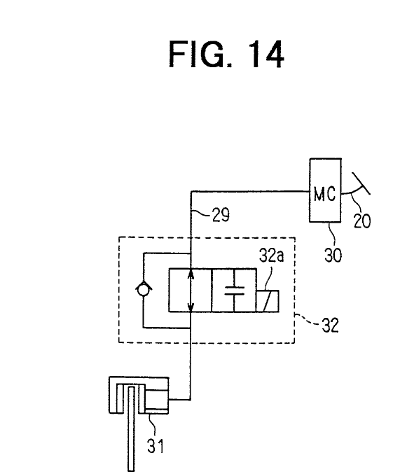

Normally, in the application of a braking force to wheels, as shown in FIG. 14, the brake pedal 20 is interlocked with a master cylinder 30 which is linked to a hydraulic pressure path 29 along with a wheel cylinder 31. In this embodiment, the auxiliary brake actuator 32 is provided at a middle position of the hydraulic pressure path 29 (or in a hydraulic pressure circuit) between the brake pedal 20 and the wheel cylinder 31. The auxiliary brake actuator 32 is a normally-open electromagnetic valve.

When a current flows through a coil 32a of the auxiliary brake actuator 32, the hydraulic pressure circuit is closed to sustain a brake hydraulic pressure on the wheel cylinder 31. In addition, when the brake pedal 20 is operated, the coil 32a is energized or excited to sustain a braking force even if the brake pedal 20 is released. The operation to sustain the braking force is an operation of auxiliary braking. That is, the stop-restart control ECU 10 controls the auxiliary brake actuator 32 by outputting a brake pressure hold signal to the auxiliary brake actuator 32.

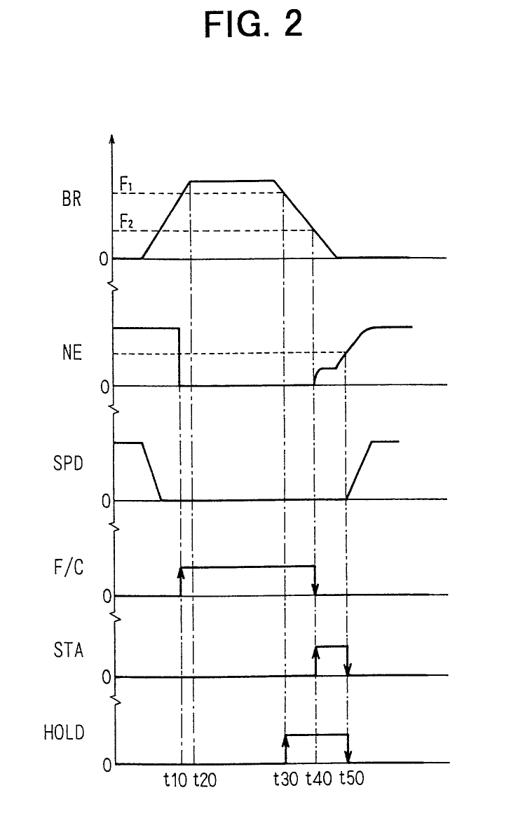

FIGS. 2 to 4 are operation diagrams for a period between an automatic stop of the engine 1 and a restart of the engine 1. Specifically, the operation diagrams of FIGS. 1 to 4 show states of a brake pedal operation quantity (BR), the engine speed (NE), the vehicle speed (SPD), a fuel cut-off signal (F/C), an engine restart signal or starter signal (STA) and a brake pressure hold signal (HOLD).

FIG. 2 shows an operation in a case that an application of the brake causes a braking force to exceed a first predetermined value F1 and an auxiliary braking force is applied prior to a restart of the engine 1.

Specifically, at time t10, that is, after a predetermined period of time has lapsed since the vehicle came to rest by the application of the brake, the engine 1 is stopped automatically. Then, at time t20, the magnitude of the braking force caused by the application of the brake by the driver reaches a peak greater than the first predetermined value F1. Then, the application of the brake is reduced in order to restart the engine 1. When the magnitude of the braking force becomes smaller than the first predetermined value F1 at time t30, the auxiliary brake (generating an auxiliary braking force) is additionally applied. Then, when the magnitude of the braking force becomes smaller than a second predetermined value F2 at time t40, the engine 1 is restarted by driving the starter motor 17. Finally, as a required output of the engine 1 is generated at time t50, the application of the auxiliary brake is discontinued.

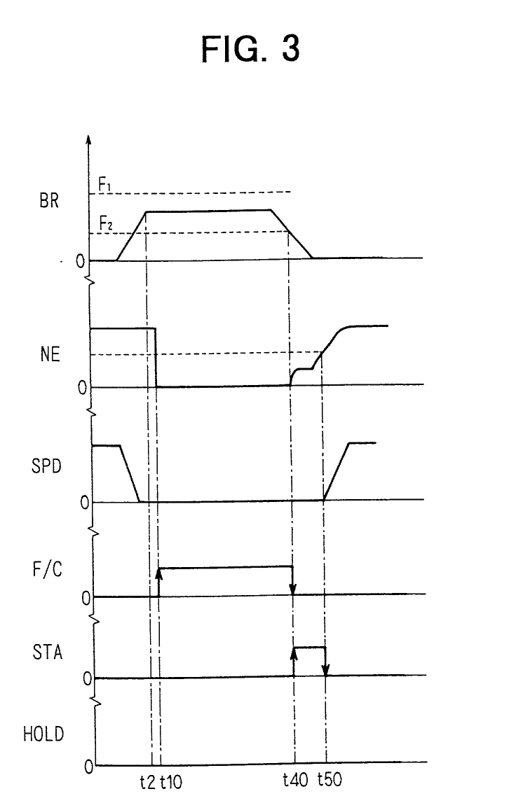

FIG. 3 shows an operation in a case that an application of the brake does not cause a braking force to exceed the first predetermined value F1 and, hence, no auxiliary braking force is applied prior to a restart of the engine 1.

Specifically, at time t2, the magnitude of the braking force caused by the application of the brake by the driver reaches a peak smaller than the first predetermined value F1. Then, at time t10, the engine 1 is automatically stopped. Thereafter, the application of the brake is reduced in order to decrease the magnitude of the braking force. Then, when the magnitude of the braking force becomes smaller than a predetermined value F2 at time t40 due to reduction of the brake, the engine 1 is restarted. Finally, as a required output of the engine 1 is generated at time t50, the operation of the auxiliary brake is discontinued.

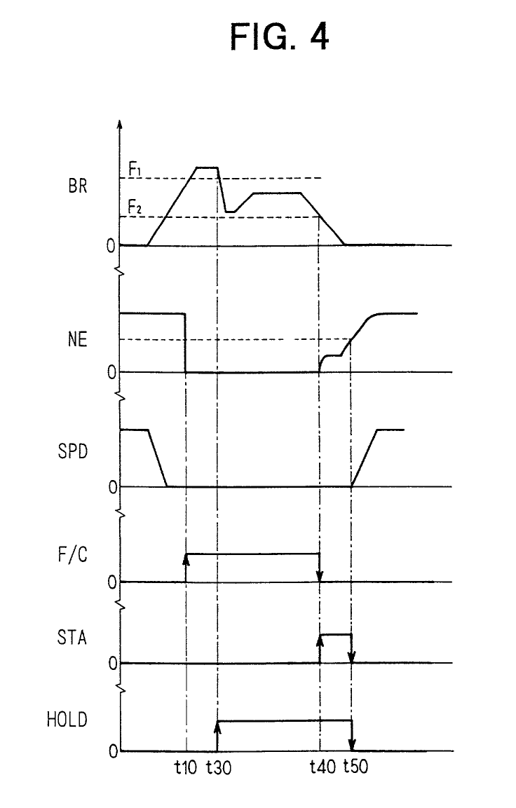

FIG. 4 shows an operation in a case that the auxiliary braking force is applied prior to a restart of the engine 1. However, before the engine 1 is restarted, the normal foot brake is reapplied.

In the case shown in FIG. 4, at time t30, when the brake is reduced to decrease the braking force to a value smaller than the first predetermined value F1 after the braking force has been determined to have exceeded the first predetermined value F1, the auxiliary brake is additionally applied. The application of the auxiliary brake is continued even after the foot brake is reapplied.

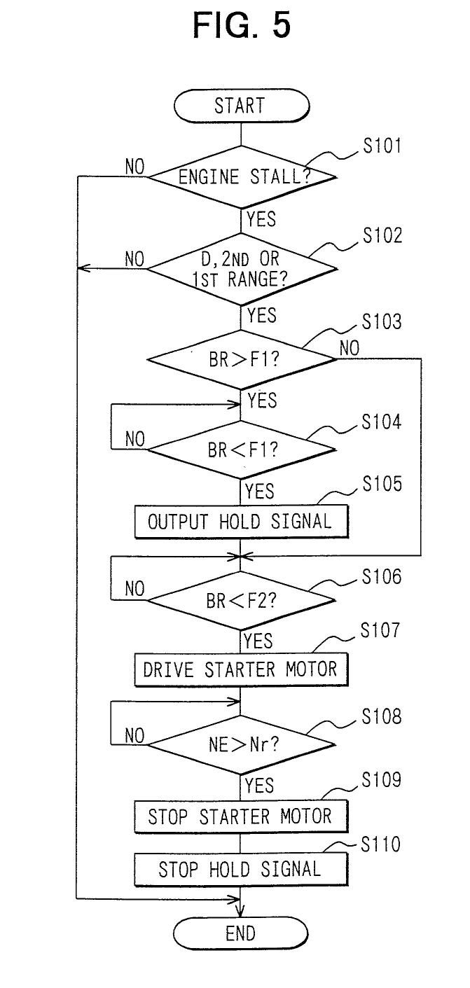

FIG. 5 is a flow diagram showing control processing to implement different kinds of control which are shown in FIGS. 2 to 4. This control processing is executed by the automatic stop-restart ECU 10.

The control processing begins with steps S101 and S102 to determine whether the engine 1 is in an automatically stopped state (engine stall). Specifically, at the first step S101, the speed of the engine 1 is checked to determine whether the engine 1 is in a stall state. If the engine 1 is in a stall state, the control processing goes on to the next step S102 to determine whether the shift lever is positioned at D (drive), 2nd speed or 1st (low) speed. It should be noted that conditions for automatically stopping the engine 1 include the lapse of a predetermined period of time since the vehicle is halted or the magnitude of an applied brake for a duration exceeding a predetermined value.

If the shift lever is positioned at D (drive), 2nd speed or 1st speed, the control processing goes on to step S103 to determine whether the magnitude of the braking force (brake operation quantity BR) has reached or exceeded the first predetermined value F1. The first predetermined value F1 is the threshold value of the braking force caused by an application of the brake. The threshold value is used for determining whether or not to start the auxiliary brake. The first predetermined value F1 is set at a value that causes no backward movement on an ordinary road for an assumed gradient of the road after the engine 1 is restarted.

The auxiliary brake is a brake generating the braking force assuring prevention of a backward movement from being caused by the vehicle when the engine 1 is restarted. That is, if the application of the brake pedal 20 is reduced after the engine 1 has been automatically stopped on a sloping road, the vehicle moves backward by the reduction of the application of the brake when the engine 1 is restarted. Thus, by operating the auxiliary brake, it is possible to prevent a backward movement from being caused by the vehicle when the engine 1 is restarted.

Thus, by determination of whether the braking force which is applied while the vehicle is being halted on a sloping surface of a road has reached or exceeded the first predetermined value F1, it is possible to determine whether to apply the auxiliary brake in dependence on the condition of the sloping surface of the road because of reasons described as follows.

That is, when the vehicle is halted on a sloping road, the magnitude of the brake applied by the driver most likely increases. Thus, if the magnitude of the brake applied by the driver is large, that is, if the braking force is large, the vehicle can be determined to have been halted on a sloping road. Therefore, in such a case, by applying the auxiliary brake after the magnitude of the brake becomes lower than the first predetermined value F1, it is possible to prevent a backward movement from being caused by the vehicle when the engine 1 is restarted.

If the magnitude of the brake applied by the driver is small, that is, if the braking force is small, on the other hand, no backward movement may be most likely caused by the vehicle when the engine 1 is restarted even if the auxiliary brake is not applied after the magnitude of the brake becomes lower than the first predetermined value F1. Thus, in this case, by inhibiting the application of the auxiliary brake, the consumption of electric power of a battery is reduced by as much as the magnitude of a current that would otherwise flow through the coil 32a employed in the auxiliary brake actuator 32 to excite the coil 32a.

For the reason described above, by determination of whether the braking force which is applied while the vehicle is being halted on a sloping surface of a road has reached or exceeded the first predetermined value F1, it is possible to determine whether the vehicle is halted on the sloping surface of the road or the like and, hence, whether to apply the auxiliary brake.

If the result of determination at step S103 is YES, the control processing goes on to step S104. If the result of determination at step S103 is NO, on the other hand, the control processing goes on to step S106.

At step S104, the braking force is examined to determine whether the braking force has become equal to or smaller than the first predetermined value F1. Step S104 is executed because the result of determination at step S103 indicates that the braking force was equal to or greater than the first predetermined value F1, determining that the vehicle is being halted on a sloping road. Later on, the driver reduces the applied brake so that the braking force becomes equal to or smaller than the first predetermined value F1. Step S104 is executed to determine whether the braking force has become equal to or smaller than the first predetermined value F1. If the braking force has become equal to or smaller than the first predetermined value F1, it is necessary to prevent a backward movement from being caused by the vehicle when the engine 1 is restarted by applying the auxiliary brake.

It should be noted that if the vehicle is halted on a road with a surface gradient exceeding an assumed value corresponding to the first predetermined value F1, a slight backward movement may possibly result during a time it takes for the braking force to decrease to the first predetermined value F1 due to the reduction of a pressing force applied to the brake pedal 20. Since such a case is very rare, however, there is no practically conceivable problem.

Then, at the next step S105, the stop-restart control ECU 10 outputs the brake pressure hold signal to the auxiliary brake actuator 32 to additionally apply the auxiliary brake. If the result of determination at step S103 indicates that the braking force is not greater than the first predetermined value F1, on the other hand, the control processing proceeds to step S106 without additionally applying the auxiliary brake.

Then, at step S106, the braking force is checked after the driver reduces the brake to determine whether the magnitude of the braking force has reached or become smaller than the second predetermined value F2. The second predetermined value F2 is set as a threshold value for restarting the engine 1. The second predetermined value F2 is smaller than the first predetermined value F1. By restarting the engine 1 after the brake is reduced to a certain degree so that the braking force becomes equal to the second predetermined value F2 in this way, it is possible to improve the responsiveness with the accelerator pedal operated to accelerate the vehicle and to prevent the vehicle from moving backward on a sloping road.

If the result of the determination is YES, the control processing goes on to step S107 at which the engine control ECU 4 outputs engine turn-on signals, that is, an ignition signal and a fuel injection signal, to the engine 1, to restart the engine 1. In addition, at this step S107, the stop-restart control ECU 10 starts the engine 1 through the engine starter 17.

The control processing then goes on to step S108 to determine whether the speed of the engine NE has reached or exceeded a predetermined value Nr. If the speed of the engine has reached or exceeded the predetermined value, the control processing goes on to step S109 at which the engine starter 17 is turned off. Then, at the next step S110, the brake pressure hold signal is turned off at time t60 shown in FIG. 3.

In this case, as a method of detecting the force of the brake, the position of the brake pedal 20 (or the operation quantity) is continuously monitored by using the brake pedal operation quantity sensor 15. As an alternative, it is also possible to use a switch which is turned on and off in dependence on the whether the position of the brake pedal 20 is beyond a predetermined operation location.

Instead of detecting the operation quantity of the brake pedal 20, the brake pressure can also measured directly. That is, a hydraulic pressure sensor 16 is employed for detecting the brake pressure as a substitute for the brake pedal operation quantity sensor 15.

According to the first embodiment, the following advantages are attained.

If a braking force applied in a stopped state of the engine 1 is greater than the first predetermined value F1, the vehicle is determined to be halted on a sloping road. As the brake is reduced so as to decrease the braking force to a level equal to or lower than the first predetermined value F1, the auxiliary brake is additionally applied (FIG. 2). As a result, the vehicle is prevented from moving backward when the engine 1 is restarted. If a braking force applied in a stopped state of the engine 1 is smaller than the first predetermined value F1, on the other hand, the engine 1 is restarted without additionally applying the auxiliary brake (FIG. 2). As a result, in a condition such as a level road where the auxiliary brake is not required, the auxiliary brake is inhibited from being applied to avoid wasteful power consumption in comparison with a case in which the auxiliary brake is always additionally applied when the engine 1 is automatically stopped.

That is, the first predetermined value F1 is set to represent a braking force on the assumption that the driver applies the brake to halt the vehicle on a sloping road. By determining whether the braking force generated with the vehicle halted is greater than the first predetermined value F1, it is possible to make a determination whether to additionally apply the auxiliary brake.

As a result, without employing an expensive device such as a gradient sensor, it is possible to determine whether the vehicle is halted on a sloping road.

The second predetermined value F2, which is used as a criterion to determine whether to restart the engine 1, is set at a level lower than the first predetermined value F1 used as a criterion to determine whether to additionally apply the auxiliary brake.

For example, assume that the first predetermined value F1 is set at a small value equal to the second predetermined value F2. In this case, the vehicle may cause a backward movement or the like during a period up to a restart of the engine 1 after reduction of the brake with the vehicle halted on a sloping road. If the second predetermined value F2 is set at a large value equal to the first predetermined value F1 in order to prevent the vehicle from moving backward on a sloping road at a restart of the engine 1, on the other hand, the engine 1 will be restarted right after the brake is reduced so that the effect of improving the fuel consumption efficiency is hardly demonstrated.

Thus, by setting the second predetermined value F2 used as a criterion to determine whether to restart the engine 1 at a level lower than the first predetermined value F1 used as a criterion to determine whether to additionally apply the auxiliary brake, it is possible to exhibit the effect of improving the fuel consumption efficiency while preventing the vehicle from moving backward on a sloping road.

(Second Embodiment)

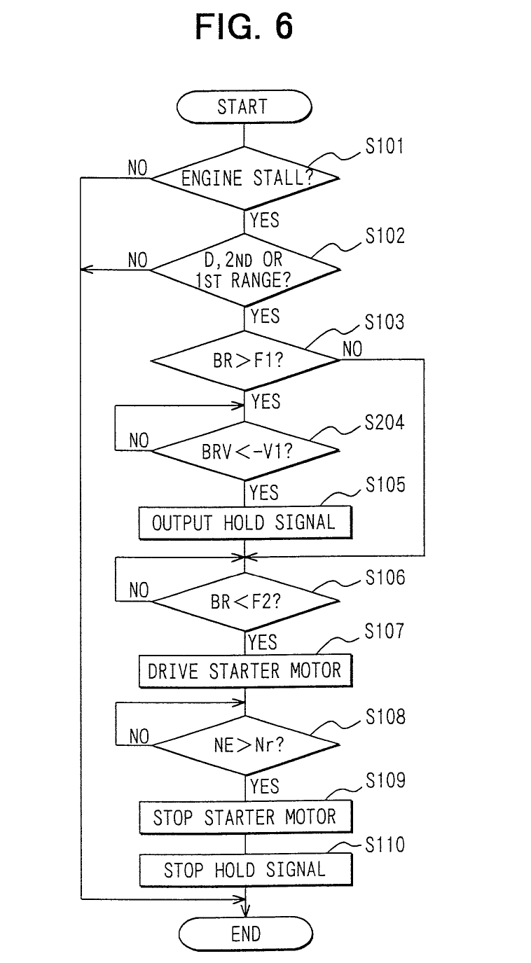

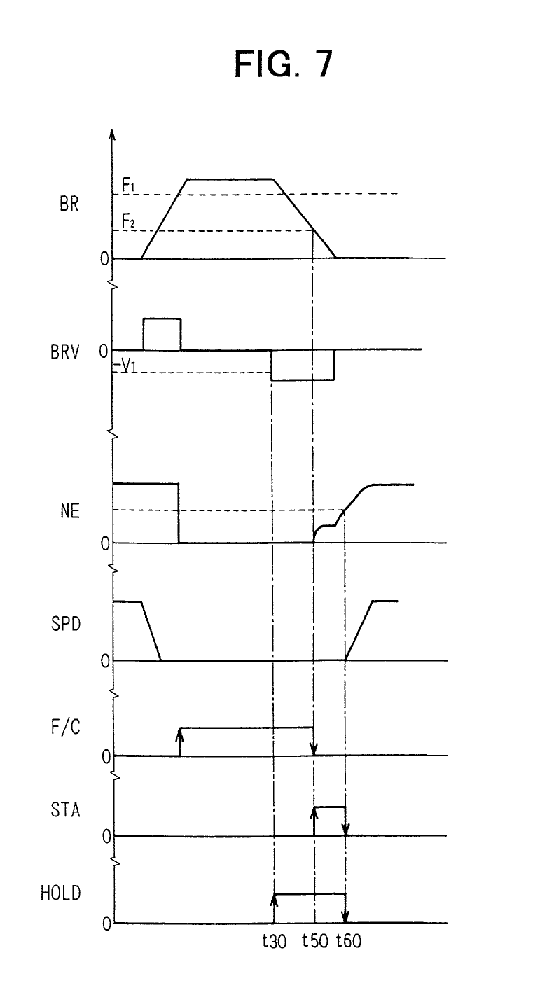

A second embodiment is shown in FIGS. 6 and 7. FIG. 6 is a flow diagram showing a restart of the engine 1 with the vehicle halted. FIG. 7 is an operation diagram of the restart. In the second embodiment, unlike step S104 in the first embodiment, a determination as to whether to additionally apply the auxiliary brake is not based on the force of the brake. Instead, the second embodiment is characterized in that a determination as to whether to additionally apply the auxiliary brake is based on a brake power generating speed as indicated with step S204 in the flow diagram shown in FIG. 6.

Specifically, the control processing shown in FIG. 6 begins with step S101 to determine whether the engine 1 is in a stall state. If the engine 1 is in a stall state, the control processing goes on to step S102 to determine whether the shift lever is set at the D (drive), 2nd speed or 1st speed position. If the shift lever is set at the D (drive), 2nd speed or 1st speed position, the control processing goes on to step S103 to determine whether the braking force has reached or exceeded the first predetermined value F1. If the result of the determination is NO, the control processing goes on to step S106. If the result of the determination is YES, on the other hand, the control processing goes on to step S204.

At step S204, the brake power generating speed is checked to determine whether the braking power generating speed BRV is equal to or lower than −V1. The brake power generating speed is checked as follows. An operation quantity of the brake pedal 20 is detected by using the brake pedal operation quantity sensor 15 for continuously monitoring the operation quantity, and the stop-restart control ECU 10 finds an operation speed of the brake pedal 20. As the brake power generating speed becomes equal to or lower than −V1 at time t30 shown in FIG. 7, the control processing goes on to step S105 at which the auxiliary brake is additionally applied.

The threshold value −V1 is set for the brake power generating speed because additional application of the auxiliary brake at a small operation quantity will be not only against the will of the driver, but also wasteful consumption of electric power. That is, the threshold value −V1 is set for preventing the auxiliary brake from being additionally applied at a small operation quantity and for avoiding such wasteful consumption of electric power. The minus sign appended to the threshold speed indicates a direction in which the brake is reduced.

The control processing then goes on to step S106 to determine whether the braking force has decreased to a value equal to or smaller than the second predetermined value F2 as a result of reduction of the brake. If the result of the determination is YES, the control processing goes on to step S107 at which the engine starter 17 is turned on. Then, the control processing goes on to step S108 to determine whether the speed of the engine 1 has reached or exceeded a predetermined value. If the speed of the engine 1 has reached or exceeded the predetermined value, the control processing goes on to step S109 at which the engine starter 17 is turned off. Then, at the next step S110, the brake pressure hold signal is turned off.

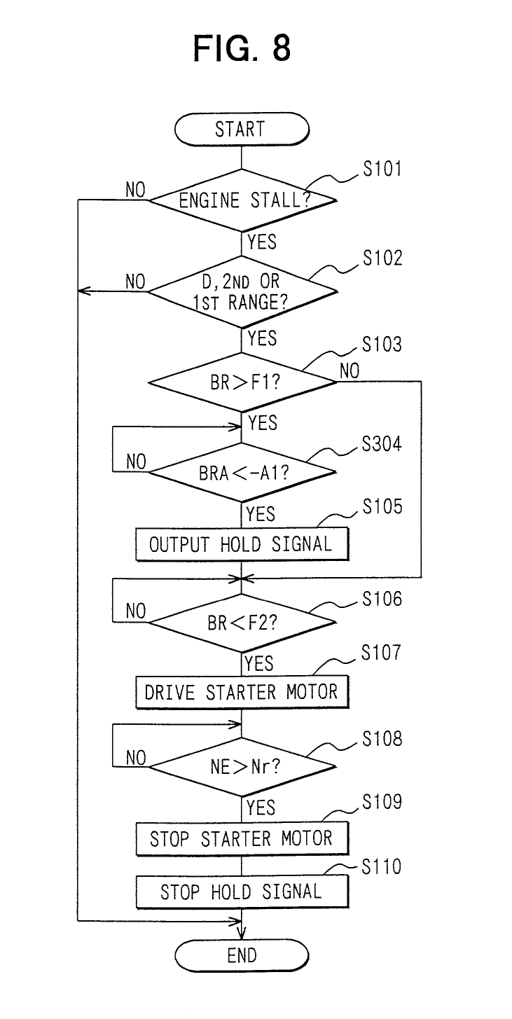

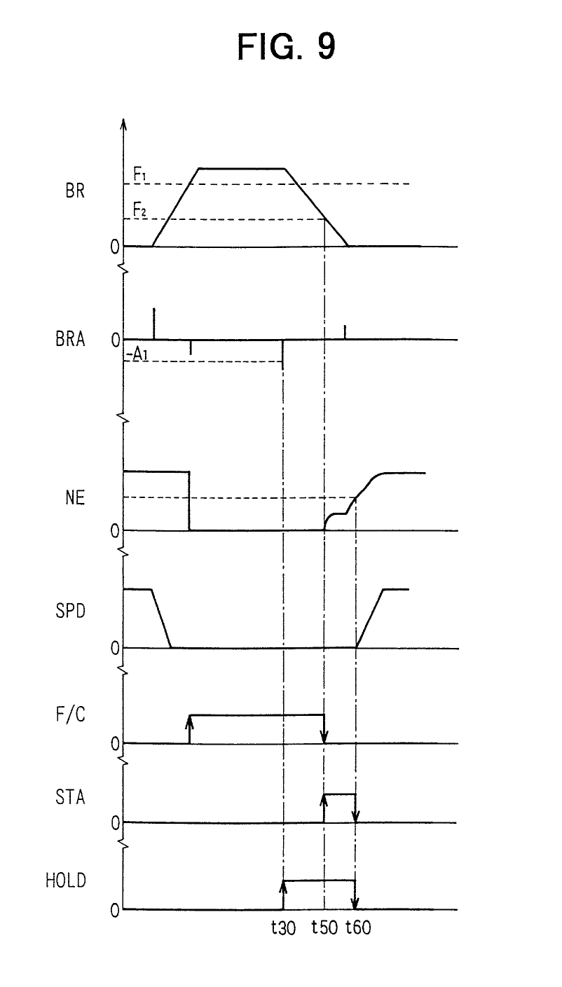

In a modification of the second embodiment, instead of detecting the speed to operate the brake, a brake operating acceleration BRA is detected at step S304 of a flow diagram shown in FIG. 8 to determine whether the acceleration has decreased to or become lower than a predetermined value −A1 (at time t30 shown in FIG. 9). The minus sign appended to the threshold acceleration A1 indicates a direction in which the brake is reduced.

It should be noted that the speed and the brake operating acceleration in this embodiment each represent the magnitude of a change in operation. On the other hand, the threshold values −V1 and −A1 each correspond to the magnitude of a predetermined change in operation.

As described above, in accordance with this embodiment, by detecting a speed or a brake operating acceleration, the intention of the driver can be detected with a high degree of accuracy and the auxiliary brake can be applied quickly.

(Third Embodiment)

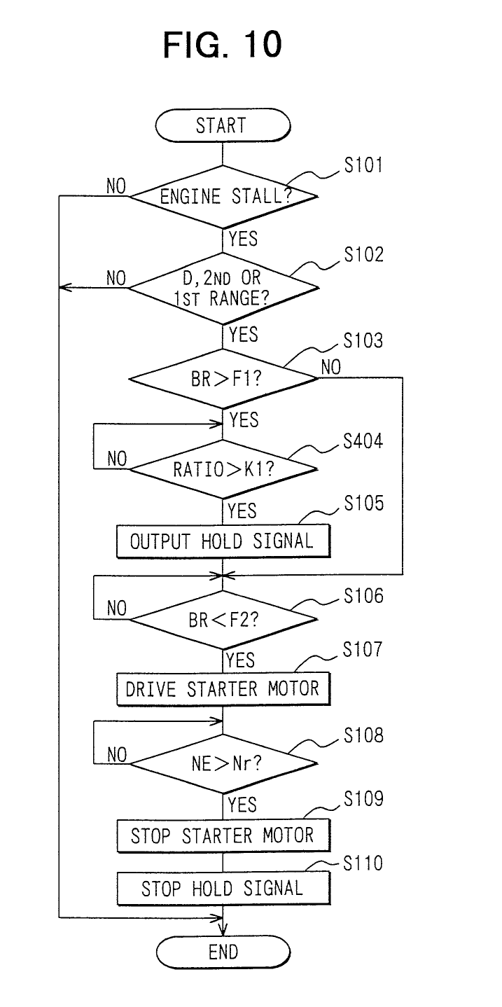

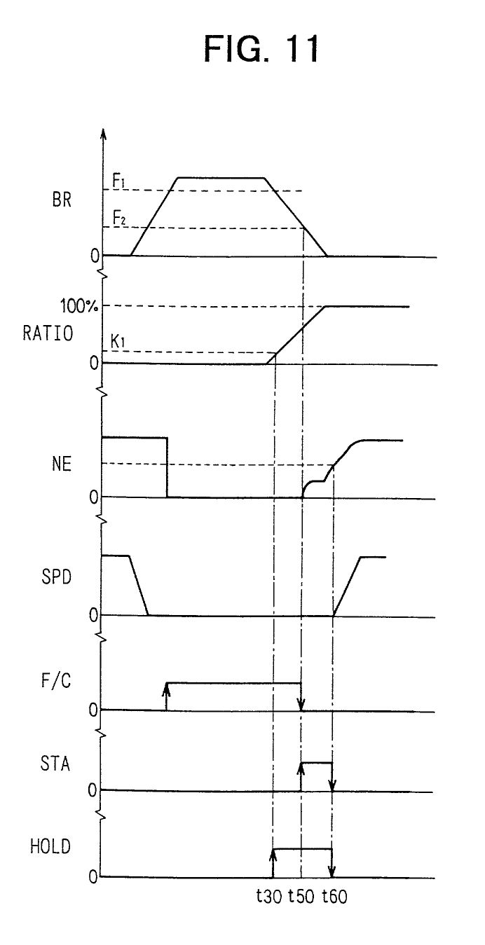

A third embodiment is shown in FIGS. 10 and 11. FIG. 10 is a flow diagram showing restart control processing of the engine 1. FIG. 11 is an operation diagram of the third embodiment. This embodiment is characterized in that the braking force applied with the engine 1 automatically stopped is used as a reference in determination of a ratio at which the brake has been released instead of determination based on the braking force in the processing carried out at step S104 of the first embodiment, determination based on the brake operating speed in the processing carried out at step S204 of the second embodiment or determination based on the brake operating acceleration in the processing carried out at step S304 in the modification of the second embodiment.

Specifically, the flow diagram shown in FIG. 10 begins with step S101 to determine whether the engine 1 is in a stall state. If the engine 1 is in a stall state, the control processing goes on to step S102 to determine whether the shift lever is set at the D (drive), 2nd speed or 1st speed position. If the shift lever is set at the D (drive), 2nd speed or 1st speed position, the control processing goes on to step S103 to determine whether the braking force has reached or exceeded the first predetermined value F1. If the result of the determination is NO, the control processing goes on to step S106. If the result of the determination is YES, on the other hand, the control processing goes on to step S404.

At step S404, a ratio of the quantity of a decrease in brake application to the quantity of the brake application at an automatic stopping time of the engine 1 is checked to determine whether the ratio has reached or exceeded a predetermined value K1. Specifically, the above ratio is a ratio of a decrease in braking force obtained as a result of releasing the brake to a reference braking force which is applied at time to automatically stop the engine 1. With the brake completely released, the ratio is thus 100%. If the ratio of a decrease in braking force to the reference braking force has reached or exceeded the predetermined value K1, the control processing goes on to step S105 at which the auxiliary brake is additionally applied at time t30 as shown in FIG. 11.

It should be noted that, as a means for detecting the ratio of a decrease in braking force to the reference braking force, the hydraulic pressure sensor 16 can be used for detecting the hydraulic pressure of the brake or the brake pedal operation quantity sensor 15 can be used for detecting the operation quantity of the brake.

The control processing then goes on to step S106 to determine whether the braking force has decreased to a value equal to or smaller than the second predetermined value F2 as a result of reduction of the brake. If the result of the determination is YES, the control processing goes on to step S107 at which the engine starter 17 is turned on. Then, the control processing goes on to step S108 to determine whether the speed of the engine 1 has reached or exceeded a predetermined value. If the speed of the engine 1 has reached or exceeded the predetermined value, the control processing goes on to step S109 at which the engine starter 17 is turned off. Then, at the next step S110, the brake pressure hold signal is turned off.

As described above, in accordance with the third embodiment, processing is carried out to monitor a ratio of a decrease in braking force obtained as a result of releasing the brake to a reference braking force which is applied at time to automatically stop the engine 1 in order to determine whether to additionally apply the auxiliary brake. Thus, the auxiliary brake can be applied at an early timing even in the case of restarting the vehicle with the engine 1 stopped automatically on a road with a steep gradient. As a result, it is possible to prevent the vehicle from moving backward.

It is therefore possible to accurately determine whether to additionally apply the auxiliary brake in accordance with the sloping state of the road.

(Fourth Embodiment)

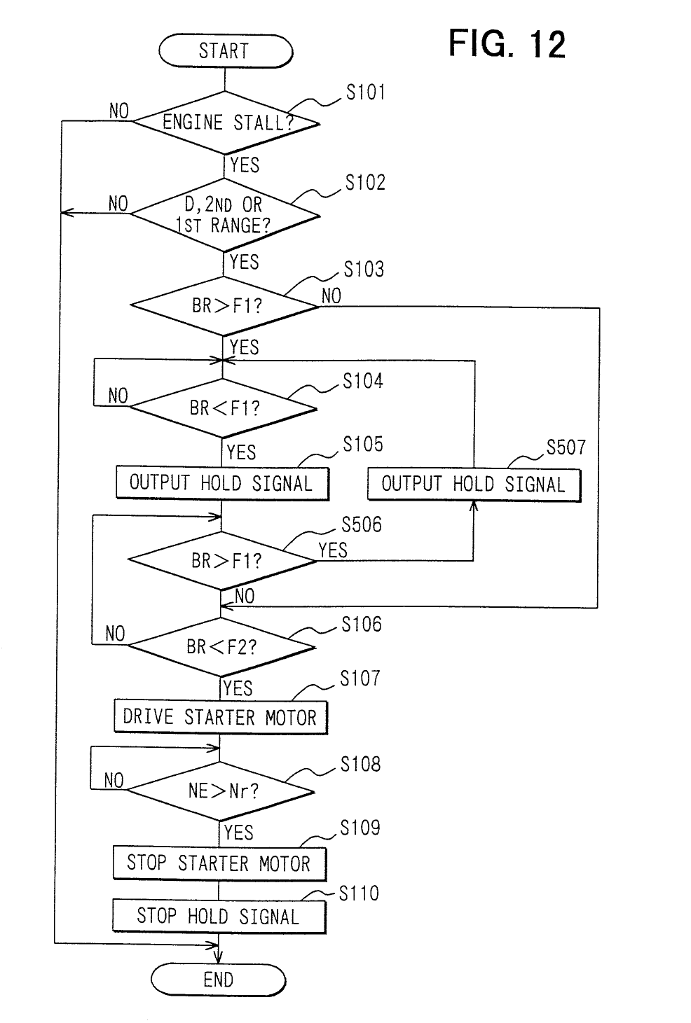

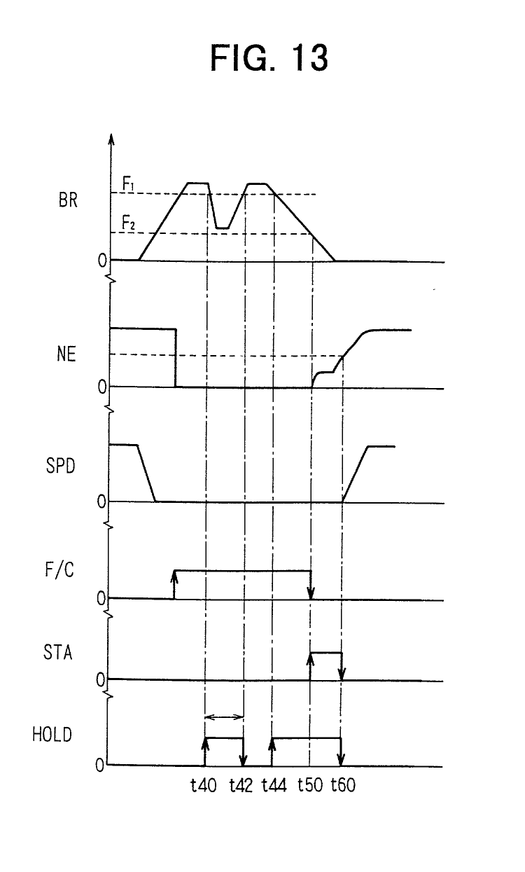

A fourth embodiment is shown in FIGS. 12 and 13. FIG. 12 is a flow diagram showing restart control processing of the engine 1 with the vehicle halted. FIG. 13 is an operation diagram showing a restart operation in the fourth embodiment. In the fourth embodiment, the brake is reapplied after the application of the auxiliary brake and, as the braking force reaches or exceeds the first predetermined value F1, the auxiliary brake is released.

It is to be noted that in the case of the first embodiment, if the braking force which is applied when the engine 1 is stopped automatically reaches or exceeds the first predetermined value F1 and then decreases to a value equal to or smaller than the first predetermined value F1 due to reduction of the brake, the auxiliary brake is additionally applied. Thereafter, the state of applying the auxiliary brake is maintained till the speed of the engine 1 reaches a predetermined value.

It should be noted that time at which the auxiliary brake is additionally applied in this embodiment can be the same as the second or third embodiment. That is, the determination of whether to additionally apply the auxiliary brake can also be based on the speed to operate the brake or the ratio of a decrease in braking force to a reference braking force.

Specifically, the control processing begins with step S101 in FIG. 10 to determine whether the engine 1 is in a stall state. If the engine 1 is in a stall state, the control processing goes on to step S102 to determine whether the shift lever is set at the D (drive), 2nd speed or 1st speed position. If the shift lever is set at the D (drive), 2nd speed or 1st speed position, the control processing goes on to step S103 to determine whether the braking force has reached or exceeded the first predetermined value F1. If the result of the determination is NO, the control processing goes on to step S106. If the result of the determination is YES, on the other hand, the control processing goes on to step S104.

At step S104, the braking force is checked to determine whether the braking force has become equal to or smaller than the first predetermined value F1 due to reduction of the brake by the driver. If the braking force has become equal to or smaller than the first predetermined value F1, the control processing goes on to step S105 at which the auxiliary brake is additionally applied at time t40 as shown in FIG. 13.

Then, the control processing goes on to step S506 to determine whether the braking force has again reached or exceeded the first predetermined value F1 because the driver has again applied the brake after the additional application of the auxiliary brake. A braking force again reaching or exceeding the first predetermined value F1 can be considered to indicate that the driver does not have an intention to restart the engine 1 and the vehicle will not move backward even if the auxiliary brake is not additionally applied. Thus, if the braking force has again reached or exceeded the first predetermined value F1, the control processing goes on to step S507 at which the brake pressure hold signal is turned off. That is, the auxiliary brake is released. Then, the control processing goes back to step S104. If the braking force did not reach or exceed the first predetermined value F1, on the other hand, the control processing goes on to step S106.

At the next step S106, the braking force is checked to determine whether the braking force has decreased to a value equal to or smaller than the second predetermined value F2 as a result of reduction of the brake. If the result of the determination is NO, the control processing goes back to step S506. If the result of the determination is YES, on the other hand, the control processing goes on to step S107.

At step S107, the engine starter 17 is turned on. Then, the control processing goes on to step S108 to determine whether the speed of the engine 1 has reached or exceeded a predetermined value. If the speed of the engine 1 has reached or exceeded the predetermined value, the control processing goes on to step S109 at which the engine starter 17 is turned off. Then, at the next step S110, the brake pressure hold signal is turned off.

As described above, in accordance with the fourth embodiment, if the braking force again reaches or exceeds the first predetermined value F1 conceivably because the driver has again applied the braking force after the additional application of the auxiliary brake, the auxiliary brake is released. Then, as the braking force again decreases to a value equal to or smaller than the first predetermined value F1, the auxiliary brake is additionally applied.

As a result, in a state where the auxiliary brake is not required, the auxiliary brake is released to avoid wasteful consumption of electric power due to a current which flows through to excite the coil 32a employed in the auxiliary brake actuator 32 should the auxiliary brake be applied all the time. In addition, it is possible to determine whether the vehicle is halted on a sloping road without employing an expensive device such as a gradient sensor.

The present invention should not be limited to the disclosed embodiment and modification, but may be modified in various ways without departing from the spirit of the invention.

What is claimed is:

1. An engine automatic stop-restart control apparatus comprising:
an engine control means for automatically stopping and restarting an engine;
an auxiliary braking force application for additionally applying an auxiliary braking force for preventing a vehicle from moving when the engine is automatically restarted after the engine is automatically stopped by the engine control means; and
an auxiliary braking force application determination means for determining whether to drive the auxiliary braking force application to apply the auxiliary braking force in accordance with a magnitude of a braking force generated by an operation of a braking force operation member.

2. The engine automatic stop-restart control apparatus according to claim 1, wherein the auxiliary braking force application additionally applies the auxiliary braking force, if the braking force generated by the braking force operation member becomes smaller than a first predetermined value after the braking force generated by the braking force operation member has reached the first predetermined value.

3. The engine automatic stop-restart control apparatus according to claim 2, wherein the auxiliary braking force application stops additionally applying the auxiliary braking force till the braking force generated by the braking force operation member becomes smaller than the first predetermined value, if the braking force generated by the braking force operation member has again reached the first predetermined value after the auxiliary braking force application has additionally applied the auxiliary braking force.

4. The engine automatic stop-restart control apparatus according to claim 1, wherein the engine control means restarts the engine, as the braking force generated by the braking force operation member becomes smaller than a second predetermined value smaller than the first predetermined value.

5. The engine automatic stop-restart control apparatus according to claim 1, further comprising:
a brake hydraulic pressure detection means for detecting the magnitude of a hydraulic pressure in a hydraulic pressure circuit of a brake,
wherein the auxiliary braking force application determination means determines whether to drive the auxiliary braking force application in accordance with the magnitude of hydraulic pressure detected by the brake hydraulic pressure detection means.

6. The engine automatic stop-restart control apparatus according to claim 1, further comprising:
an operation-quantity detection means for detecting a quantity of operation of the braking force operation member,
wherein the auxiliary braking force application determination means determines whether to drive the auxiliary braking force application in accordance with the quantity of operation of the braking force operation member.

7. The engine automatic stop-restart control apparatus according to claim 1, wherein the auxiliary braking force application additionally applies the auxiliary braking force, if a magnitude of a change in operation of the braking force operation member becomes smaller than a predetermined operation change magnitude after the braking force generated by the braking force operation member has reached the first predetermined value.

8. The engine automatic stop-restart control apparatus according to claim 1, wherein the auxiliary braking force application additionally applies the auxiliary braking force, when a decrease in the braking force is caused as a result of releasing the braking force operation member relative to a reference which is generated by the braking force operation member while the engine is being automatically stopped, if a ratio of the decrease in braking force to the reference becomes greater than a predetermined value after the braking force generated by the braking force operation member has reached the first predetermined value.

9. An engine automatic-restart control method for a vehicle having an engine and a braking force operation member, the method comprising the steps of:
detecting an operation condition of the braking force operation member when the engine is held stopped;
applying automatically an auxiliary braking force to the vehicle when a detection result of the detecting step indicates a decrease in a braking force applied to the vehicle; and
restarting automatically the engine when the detection result of the detecting step indicates a release of the braking force operation member while maintaining the auxiliary braking force.
